(19) United States
(12) Patent Application Publication
(10) Pub. No.: US 2026/0016372 A1
(43) Pub. Date: Jan. 15, 2026

(54) POLARITY, INSERTION LOSS AND RETURN LOSS TESTER FOR MULTI-CORE OPTICAL FIBER

(71) Applicant: SHENZHEN WEIDU TECHNOLOGY CO., LTD., Shenzhen (CN)

(72) Inventors: Qi ZHOU, Shenzhen (CN); Jianping LIU, Meizhou (CN); Qihuan LUO, Shenzhen (CN)

(73) Assignee: SHENZHEN WEIDU TECHNOLOGY CO., LTD., Shenzhen (CN)

(21) Appl. No.: 19/334,872

(22) Filed: Sep. 21, 2025

Related U.S. Application Data
(63) Continuation of application No. PCT/CN2023/088422, filed on Apr. 14, 2023.

(51) Int. Cl. G01M 11/00

(52) U.S. Cl. CPC G01M 11/35; G01M 11/337

(57) ABSTRACT

Disclosed in the present invention is a polarity, insertion loss and return loss tester for a multi-core optical fiber, the tester comprising an integrating sphere, wherein the integrating sphere has an incident light channel, the incident light channel comprising an incidence end, an integrating sphere cavity and a receiving end, which are sequentially in communication with each other; the integrating sphere is further provided with a reflected light channel in communication with the incident light channel, a lens assembly and an imaging device being provided in the reflected light channel; a semi-transparent and semi-reflective reflector is fixedly arranged in the incident light channel, or a movable reflective mirror is provided in the incident light channel; and incident light is reflected by the reflective mirror or the semi-transparent and semi-reflective reflector, and is then converged by the lens assembly onto the imaging device for imaging. In the present invention, return loss testing, insertion loss testing, and polarity testing of a winding-free multi-core optical fiber patch cord are carried out on one apparatus, such that the cost is reduced, and the efficiency is improved. Moreover, the reliability and accuracy of the measurement of an insertion loss value and a return loss value are also ensured on the premise of improving efficiency.

### TECHNICAL FIELD

The present disclosure relates to the technical field of optical fiber detection, and more particularly to a polarity, insertion loss and return loss tester for multi-core optical fiber capable of testing the polarity, insertion and return loss value of the multi-core optical fiber patch cord.

### BACKGROUND OF THE INVENTION

With the construction of 5G and the increasing requirements for data communication bandwidth in the big data field, the number of optical communications and its ancillary industries is also growing; insertion and return loss detection products have reached the international advanced level, and the integration of multiple test functions is now the subsequent trend.

In current, optical fiber insertion loss detection and multi-core optical fiber polarity detection are performed separately on two devices, and rewiring is required to detect the insertion loss value and polarity. The cost of using two devices is relatively higher, and two detection means cannot be integrated at one workstation. Two workers are required to operate, which is inefficient. Moreover, joint realization of the two functions requires more optimized structural design and operation design.

### SUMMARY OF THE INVENTION

Features and advantages of the present invention are set forth in part in the following description, or might be obvious from the above description, or might be learned through practice of the present invention.

The objection of the present invention is to provide a polarity, insertion loss and return loss tester for multi-core optical fiber, which can realize insertion and return loss test and polarity test in one device, thereby reducing costs and improving efficiency.

A main technical solution is provided to solve the technical problems mentioned above as follows. A polarity, insertion loss and return loss tester for a multi-core optical fiber is provided, which comprises an integrating sphere, wherein the integrating sphere has an incident light chan-nel, the incident light channel comprising an incidence end, an integrating sphere cavity and a receiving end, which are sequentially in communication with each other; the integrating sphere is further provided with a reflected light channel, which is in communication with the incident light channel; a lens assembly and an imaging device being provided in the reflected light channel.

A semi-transparent and semi-reflective reflector is fixedly disposed in the incident light channel or a movable reflective mirror is disposed in the incident light channel; and incident light is reflected by the reflective mirror or the semi-transparent and semi-reflective reflector, and is then converged through the lens assembly onto the imaging device for imaging.

The reflective mirror is a total reflective mirror, and the total reflective mirror is rotatably installed in the incident end.

The integrating sphere is provided with a driving device, which drives the total reflective mirror to rotate.

The driving device is a steering gear, a rotating shaft of the steering gear is connected to a rotating stand located in the incident end, and the total reflective mirror is installed on the rotating stand or is integrated with the rotating stand.

The reflecting mirror or the semi-transparent and semi-reflecting mirror is arranged in the incident end; or the reflecting mirror or the semi-transparent and semi-reflecting mirror is arranged in the integrating sphere cavity; or the reflecting mirror or the semi-transparent and semi-reflecting mirror is arranged in the receiving end.

The reflective mirror is a total reflective mirror, and the total reflective mirror is installed in the incident end in a translationally movable manner.

The reflective mirror is a semi-transparent and semi-reflective reflector which is rotatably installed in the incident end.

The reflective mirror is a semi-transparent and semi-reflective reflector which is installed in the incident end in a translationally movable manner.

The imaging device is a camera or a sensor, and the camera or the sensor is installed in the reflection light channel through a translation bracket.

The lens assembly is a convex lens or a combination of a convex lens and a concave lens.

Since the reflective mirror is movable, when performing return loss and insertion loss tests on a multi-core optical fiber patch cord, the reflective mirror is moved to a position where the incident light is not blocked. In this way, the incident light of the optical fiber cores of the multi-core optical fiber patch cord enters the integrating sphere cavity from the incident end, is reflected by the integrating sphere cavity, and then converges into the receiving end of a photodetector, thereby performing return loss and insertion loss tests. When performing a polarity test on a multi-core optical fiber patch cord, the reflective mirror is moved to a set position. After the incident light from a certain fiber core of the multi-core optical fiber patch cord is reflected by the reflective mirror, the incident light is converged by the lens assembly and forms a bright spot image on the imaging device. Then the fiber core is switched, and the next fiber core will also form a bright spot on the imaging device. After all the fiber cores are tested, each fiber core will have a corresponding bright spot position on the imaging device, and each bright spot position will be different. These bright spot positions are then compared with the bright spot positions formed by the fiber cores of the multi-core optical fiber patch cord with standard polarity to confirm the polarity of the tested multi-core optical fiber patch cord. Similarly, if a semi-transparent and semi-reflective reflector is used, part of the incident light from a certain fiber core of the multi-core optical fiber patch cord is reflected, and the other part enters the integrating sphere cavity, is reflected by the integrating sphere cavity, and then converges into the receiving end of the photodetector, thereby performing return loss test and insertion loss test. The reflected incident light is converged by the lens assembly and forms a bright spot image on the imaging device. Then the fiber core is switched, and the next fiber core will also form a bright spot on the imaging device. After all fiber cores are tested, each fiber core will have a corresponding bright spot position on the imaging device. Each bright spot position will be different. These bright spot positions are then compared with the bright spot positions formed by the multi-core fiber patch cord with standard polarity to confirm the polarity of the tested multi-core fiber patch cord. In this way, the present invention realizes the return loss test and insertion loss test of the tangle-free multi-core optical fiber patch cord on a single device, and simultaneously realizes the polarity test of the multi-core optical fiber patch cord, thereby reducing costs and improving efficiency. Moreover, while improving efficiency, the reliability and accuracy of the insertion loss and return loss value measurements are also guaranteed.

### BRIEF DESCRIPTION OF DRAWINGS

The present invention is described in detail with reference to the following embodiments. By referring to the accompanying drawings and combining them with examples, the advantages and implementation of the present invention will become more apparent. The content shown in the drawings is only for the purpose of explaining and illustrating the present invention, and does not constitute any limitation on the present invention in any sense.

FIG. 1 is a schematic structural view of a polarity, insertion loss and return loss tester for multi-core optical fiber according to an embodiment of the present invention.

FIG. 2 is a schematic perspective view of an integrating sphere in the embodiment of the present invention.

FIG. 3 is a schematic sectional view of the integrating sphere with a reflective mirror inside in a first status according to a first embodiment of the present invention.

FIG. 4 is a schematic sectional view of the integrating sphere with the reflective mirror inside in a second status according to the first embodiment of the present invention.

FIG. 5 is a schematic view showing positions of bright spots formed by different fiber cores on the imaging device in the first embodiment of the present invention.

FIG. 6 is a schematic structural view of a rotating stand installed on the steering gear in the first embodiment of the present invention.

FIG. 7 is a schematic structural view of the explored rotating stand and the steering gear separated in the first embodiment of the present invention.

FIG. 8 is an explored schematic view of the integrating sphere in accordance with the first embodiment of the present invention.

FIG. 9 is a schematic sectional view of the integrating sphere with a semi-transparent and semi-reflective reflector inside in a first status according to a second embodiment of the present invention.

FIG. 10 is a schematic sectional view of the integrating sphere with a semi-transparent and semi-reflective reflector inside in a second status according to a third embodiment of the present invention.

### DETAILED DESCRIPTION OF THE INVENTION

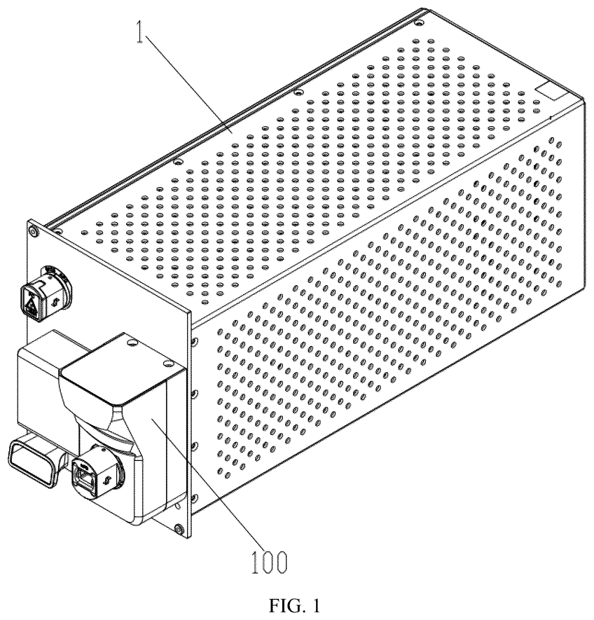

As shown in FIGS. 1 through 3, in accordance with an embodiment of the present invention, a polarity, insertion loss and return loss tester for multi-core optical fiber is provided, which is an improvement based on the existing insertion and return loss tester, so that the insertion and return loss tester has a multi-core optical fiber polarity test function, while the return loss test and insertion loss test are consistent with the existing ones.

The polarity, insertion loss and return loss tester for multi-core optical fiber comprises an integrating sphere 100, wherein the integrating sphere 100 comprises an incidence end 102, an integrating sphere cavity 101 and a receiving end 103, which are sequentially in communication with each other, and thus cooperatively form an incident light channel. The incident end 102 is connected to a MPO adapter 104, and the MPO adapter 104 is configured to connect to the MPO fiber patch cord. The receiving end 103 is a photoelectric detector receiving end (i.e., a PD receiving end).

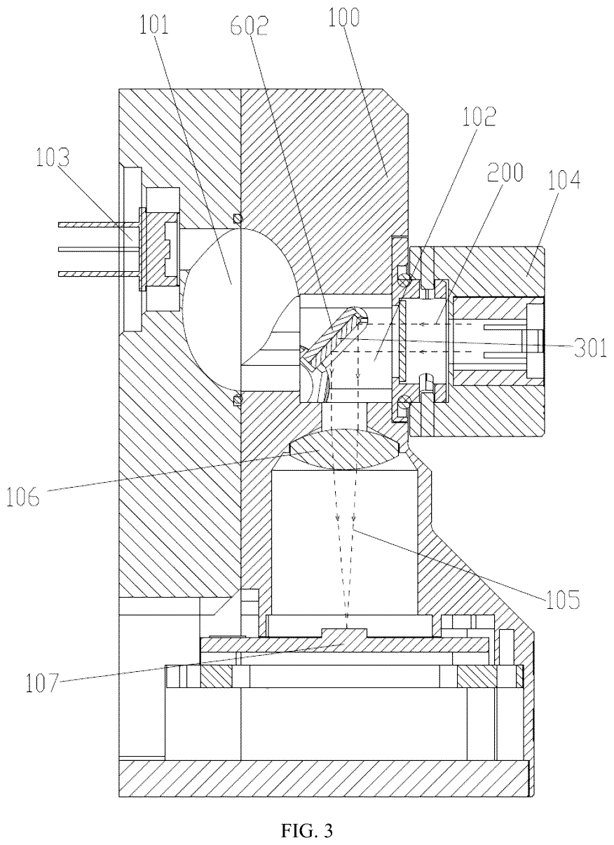

As shown in FIG. 3, the integrating sphere 100 is further provided with a reflected light channel 105 in communication with the incident light channel; and a lens assembly and an imaging device 107 are provided in the reflected light channel 105. A movable reflective mirror is disposed in the incident light channel or a semi-transparent and semi-reflective reflector is fixedly disposed in the incident light channel; and incident light 200 is reflected by the reflective mirror or the semi-transparent and semi-reflective reflector, and is then converged through the lens assembly onto the imaging device 107 for imaging.

Since the reflective mirror is movable, when performing return loss and insertion loss tests on a multi-core optical fiber patch cord, the reflective mirror is moved to a position where the incident light is not blocked. In this way, the incident light of the optical fiber cores of the multi-core optical fiber patch cord enters the integrating sphere cavity from the incident end, is reflected by the integrating sphere cavity, and then converges into the PD receiving end, thereby performing return loss and insertion loss tests. When performing a polarity test on a multi-core optical fiber patch cord, the reflective mirror is moved to a set position. After the incident light from a certain fiber core of the multi-core optical fiber patch cord is reflected by the reflective mirror, the incident light is converged by the lens assembly and forms a bright spot image on the imaging device. Then the fiber core is replaced, and the next fiber core will also form a bright spot on the imaging device. After all the fiber cores are tested, each fiber core will have a corresponding bright spot position on the imaging device, and each bright spot position will be different. These bright spot positions are then compared with the bright spot positions formed by the fiber cores of the multi-core optical fiber patch cord with standard polarity to confirm the polarity of the tested multi-core optical fiber patch cord. Similarly, if a semi-transparent and semi-reflective reflector is used, part of the incident light from a certain fiber core of the multi-core optical fiber patch cord is reflected, and the other part enters the integrating sphere cavity, is reflected by the integrating sphere cavity, and then converges into the PD receiving end, thereby performing return loss test and insertion loss test. The reflected incident light is converged by the lens assembly and forms a bright spot image on the imaging device. Then the fiber core is replaced, and the next fiber core will also form a bright spot on the imaging device. After all fiber cores are tested, each fiber core will have a corresponding bright spot position on the imaging device. Each bright spot position will be different. These bright spot positions are then compared with the bright spot positions formed by the multi-core fiber patch cord with standard polarity to confirm the polarity of the tested multi-core fiber patch cord. In this way, the present invention realizes the return loss test and insertion loss test of the tangle-free multi-core optical fiber patch cord on a single device, and simultaneously realizes the polarity test of the multi-core optical fiber patch cord, thereby reducing costs and improving efficiency. Moreover, while improving efficiency, the reliability and accuracy of the insertion loss and return loss value measurements are also guaranteed.

### EMBODIMENTS OF THE PRESENT INVENTION

The present invention is described in detail with reference to the following embodiments.

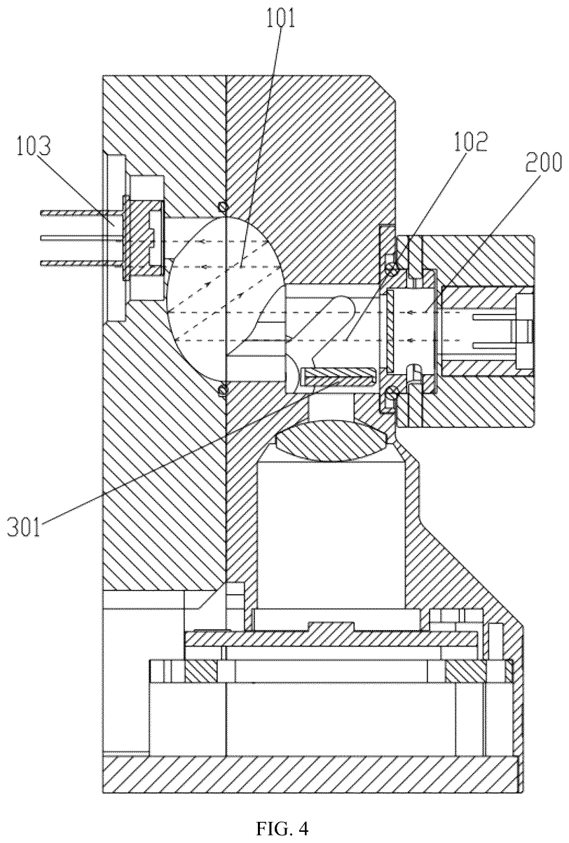

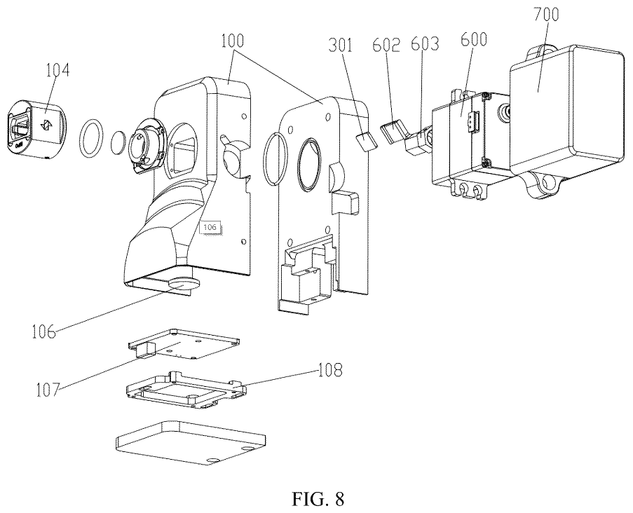

As shown in FIG. 3 and FIG. 4, in accordance with a first embodiment of the present invention, the reflective mirror is a total reflective mirror 301, and the total reflective mirror 301 is rotatably installed in the incident end 102. In this embodiment, the incident end 102 has a certain volume, and the reflective mirror is disposed in the incident end 102. Referring to FIG. 7, the lens assembly is preferably a convex lens 106, and the imaging device 107 is a camera or a sensor, which is installed in the reflection light channel through a translation bracket 107. The imaging device could also be other sensors with imaging functions.

Referring to FIG. 3, when performing a polarity test on a multi-core optical fiber patch cord, the total reflective mirror 301 is rotated to a certain angle (preferably 45 degrees) with respect to the horizontal plane, and a certain fiber core of the multi-core optical fiber patch cord is selected. After the incident light 200 of the certain fiber core is reflected by the total reflective mirror 301, the incident light 200 is converged by the convex lens 106 and forms a bright spot image on the imaging device 107. Then the fiber core is replaced, and the next fiber core will also form a bright spot on the imaging device 107. After all the fiber cores are detected, each fiber core will have a corresponding bright spot position on the imaging device, and each bright spot position will be different. The positions of these bright spots are then compared with the positions of the bright spots formed by the multi-core optical fiber patch cord with standard polarity to confirm the polarity of the tested multi-core optical fiber patch cord.

Referring to FIG. 4, when performing a return loss test and an insertion loss test on a multi-core optical fiber patch cord, the total reflective mirror 301 is rotated to be parallel to a horizontal plane so that the total reflective mirror 301 does not block the incident light 200. In this way, the incident light 200 of the fiber core of the multi-core optical fiber patch cord enters the integrating sphere cavity 101 from the incident end 102, is reflected by the integrating sphere cavity 101, and then enters the receiving end 103, thereby performing a return loss test and an insertion loss test.

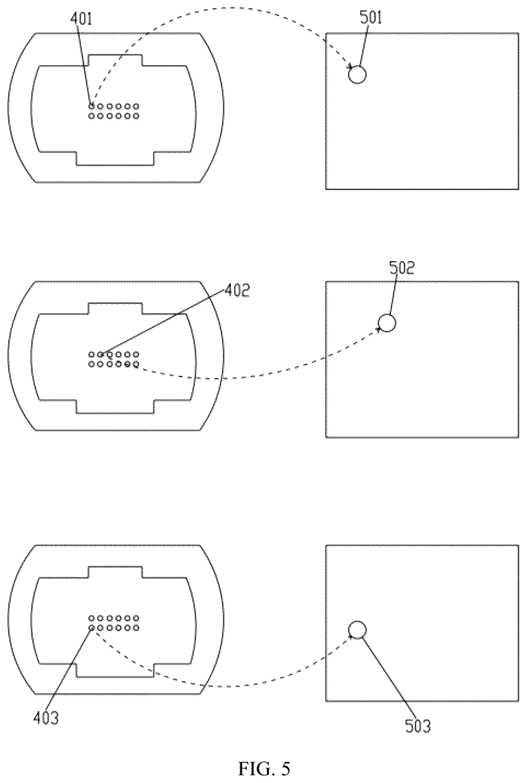

As shown in FIG. 5, the principle of polarity determination is explained using a 12-core MPO optical fiber patch cord as an example.

The 12-core fiber cores are arranged in two rows and six columns, with a first fiber core 401 located in the first row and first column, a second fiber core 402 located in the first row and second column, and a third fiber core 403 located in the second row and first column. During polarity testing, the first fiber core 401 is first selected in a channel. The incident light from the first fiber core 401 forms a first bright spot 501 on the imaging device. The channel is then switched to the channel of the second fiber core 402. The incident light from the second fiber core 402 forms a second bright spot 502 on the imaging device, located to the right of the first bright spot 501. The channel is then switched to the channel of the third fiber core 403. The incident light from the third fiber core 403 forms a third bright spot 503 on the imaging device, located below the first bright spot 501. This process is repeated until 12 bright spot positions or coordinates are obtained. These 12 bright spot positions or coordinates are then compared with the bright spot positions formed by the cores of multi-core fiber patch cords with standard polarity (MPO optical fiber patch cords have three common polarities: type A, type B, and type C) to confirm the polarity of the tested multi-core fiber patch cord. The above principle is also applicable to 24-core MPO optical fiber patch cords, 48-core MPO optical fiber patch cords, etc.

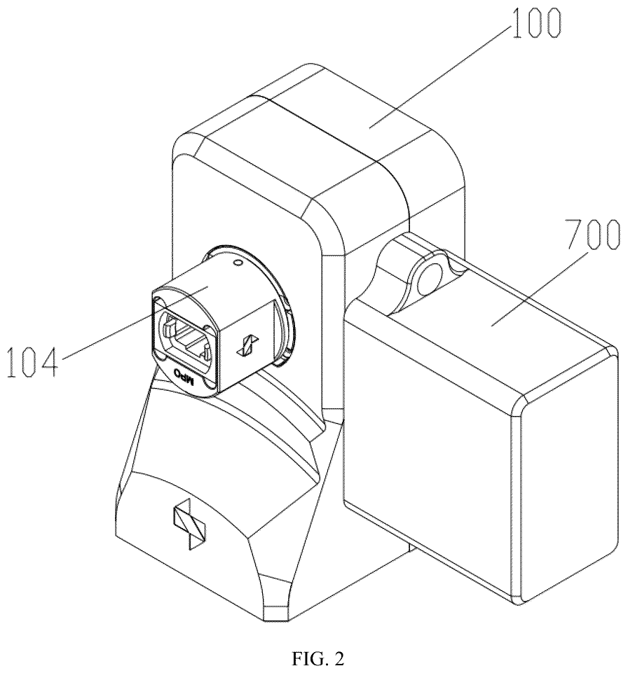

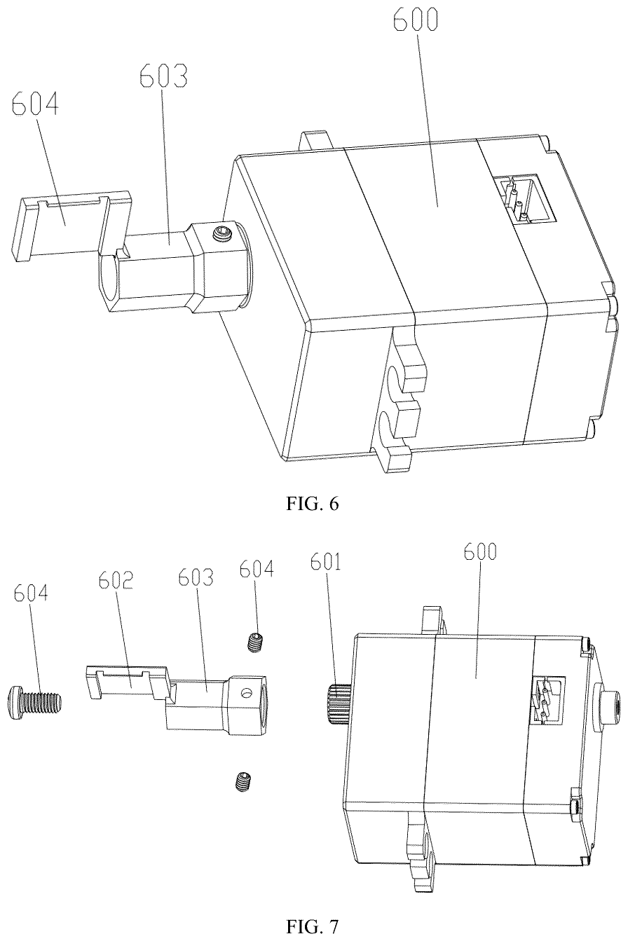

Referring to FIGS. 2, 6, 7 and 8 together, a driving device is provided on the integrating sphere, which drives the total reflective mirror to rotate. In this embodiment, the driving device is a steering gear 600. It is to be understood that the driving device could be a motor, an electric motor, etc., as long as it can drive the total reflective mirror to rotate. A rotating shaft 601 of the steering gear 600 is connected to a rotating stand 602 located in the incident end 102. The rotating stand 602 could be a solid plate or a hollow plate. The total reflective mirror 301 is mounted on the rotating stand 602 or is integrated as a whole with the rotating stand 602. The total reflective mirror could also be directly connected to the rotating shaft of the steering gear. The steering gear 600 drives the total reflective mirror 301 to rotate, so that the incident light is not blocked when the insertion loss detection is performed.

In this embodiment, the rotating stand 602 is installed at one end of a connecting shaft 603, and the other end of the connecting shaft 603 is connected to the rotating shaft 601 of the steering gear 600. The connecting shaft 603 is further connected to the rotating shaft 601 of the steering gear 600 via a screw 604.

As shown in FIG. 2 and FIG. 8, a protective cover 700 is provided on the steering gear 600, and the protective cover 700 is fixedly connected to the integrating sphere 100.

In addition, the total reflective mirror could also be installed in the incident end in a translational manner. When performing a polarity test on a multi-core optical fiber patch cord, the total reflective mirror is translated to a preset position so that the total reflective mirror reflects the incident light. When performing return loss test and insertion loss test of multi-core optical fiber patch cord, the total reflective mirror is moved to a preset position so that the total reflective mirror does not block the incident light.

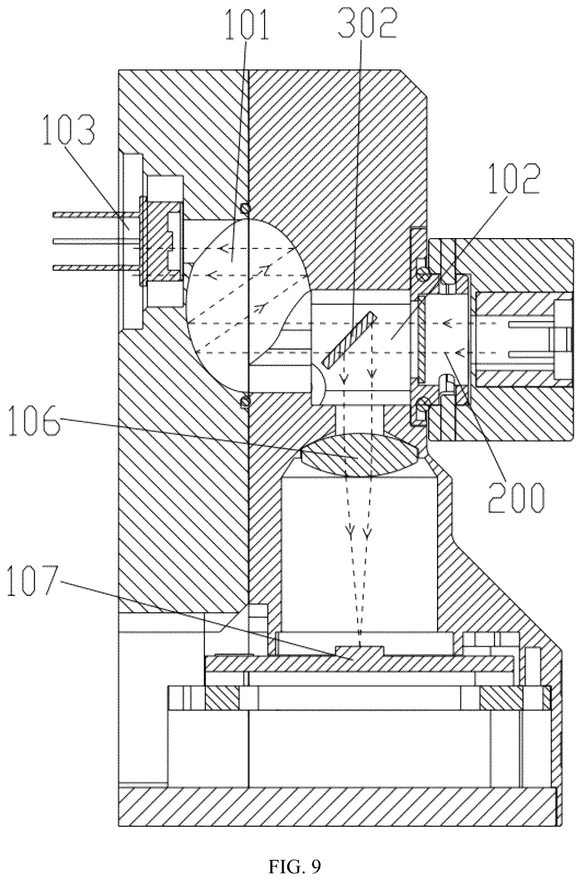

As shown in FIG. 9, in a second embodiment, a semi-transparent and semi-reflective reflector 302 is used, and the semi-transparent and semi-reflective reflector 302 is fixedly arranged in the incident light channel. In this embodiment, the semi-transparent and semi-reflective reflector 302 is fixedly disposed in the incident end 102.

In the embodiment using the semi-transparent and semi-reflective reflector, part of the incident light 200 of a certain fiber core of the multi-core fiber patch cord is reflected by the semi-transparent and semi-reflective reflector 302, and the other part enters the integrating sphere cavity 101, is reflected by the integrating sphere cavity 101, and then converges into the PD receiving end, thereby performing return loss test and insertion loss test. The reflected incident light 200 is converged by the convex lens 106 and forms a bright spot image on the imaging device 107. Then the fiber core is replaced, and the next fiber core will also form a bright spot on the imaging device 107. After all the fiber cores are detected, each fiber core will correspond to a bright spot position on the imaging device, and each bright spot position will be different. These bright spot positions are then compared with the bright spot positions formed by the cores of the multi-core fiber optic patch cord with standard polarity to confirm the polarity of the detected multi-core fiber optic patch cord. The polarity detection principle is the same as that of the first embodiment.

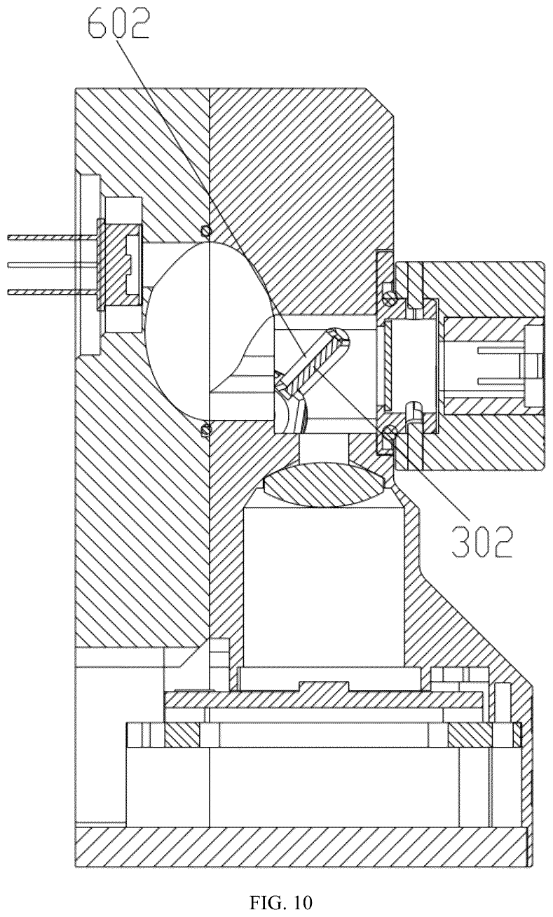

As shown in FIG. 10, in a third embodiment, the semi-transparent and semi-reflective reflector 302 could also be rotatably installed in the incident end. The semi-transparent and semi-reflective reflector 302 could be installed on a hollow rotating stand 602. The structure used for rotation in the third embodiment is the same as that in the first embodiment.

The semi-transparent and semi-reflective reflector could also be movably installed in the incident end. When performing polarity detection on a multi-core optical fiber patch cord, the total reflective mirror is translated to a preset position so that the total reflective mirror reflects incident light. When performing return loss test and insertion loss test of multi-core optical fiber jumper, the total reflective mirror is moved to a preset position so that the total reflective mirror does not block the incident light.

The polarity, insertion loss and return loss tester of the multi-core optical fiber of the present invention comprises an insertion loss test module, an imaging device, a steering engine and a control circuit. The polarity, insertion loss and return loss tester of the multi-core optical fiber and the optical fiber optical path selection switch are combined and connected to a host computer using an interface control circuit. A single-core optical fiber patch cord is used to connect an optical output port of the tester and an input port of the optical fiber optical path selection switch. Each branch channel of the optical fiber optical path selection switch is connected to the channel of the MPO optical fiber patch cord one by one, and a tail end of the MPO optical fiber patch cord is connected to the optical input end of the integrating sphere. The host computer controls the tests of return loss, insertion loss and polarity.

The above is only a preferred embodiment of the disclosure and does not impose any formal limitations on it. Therefore, any simple modifications, equivalent changes, and modifications made to the above embodiments base 10d on the technical essence of the disclosure, which are not separated from the technical solution of the disclosure, shall fall within the scope of protection of the technical solution of the disclosure.

1. A polarity, insertion loss and return loss tester for multi-core optical fiber, comprising an integrating sphere, wherein the integrating sphere has an incident light channel, the incident light channel comprises an incidence end, an integrating sphere cavity and a receiving end, which are sequentially in communication with each other; wherein the integrating sphere is further provided with a reflected light channel in communication with the incident light channel; a lens assembly and an imaging device is provided in the reflected light channel; a semi-transparent and semi-reflective reflector is fixedly disposed in the incident light channel or a movable reflective mirror disposed in the incident light channel; and incident light is reflected by the reflective mirror or the semi-transparent and semi-reflective reflector, and is then onverged through the lens assembly onto the imaging device for imaging.

2. The polarity, insertion loss and return loss tester for multi-core optical fiber according to claim 1, wherein the reflective mirror is a total reflective mirror, and the total reflective mirror is rotatably installed in the incident end.

3. The polarity, insertion loss and return loss tester for multi-core optical fiber according to claim 2, wherein the integrating sphere is provided with a driving device, which drives the total reflective mirror to rotate.

4. The polarity, insertion loss and return loss tester for multi-core optical fiber according to claim 3, wherein the driving device is a steering gear, a rotating shaft of the steering gear is connected to a rotating stand located in the incident end, and the total reflective mirror is installed on the rotating stand or is integrated with the rotating stand.

5. The polarity, insertion loss and return loss tester for multi-core optical fiber according to claim 1, wherein the reflecting mirror or the semi-transparent and semi-reflecting mirror is arranged in the incident end; or the reflecting mirror or the semi-transparent and semi-reflecting mirror is arranged in the integrating sphere cavity; or the reflecting mirror or the semi-transparent and semi-reflecting mirror is arranged in the receiving end.

6. The polarity, insertion loss and return loss tester for multi-core optical fiber according to claim 1, wherein the reflective mirror is a total reflective mirror, and the total reflective mirror is installed in the incident end in a translationally movable manner.

7. The polarity, insertion loss and return loss tester for multi-core optical fiber according to claim 1, wherein the reflective mirror is a semi-transparent and semi-reflective reflector which is rotatably installed in the incident end.

8. The polarity, insertion loss and return loss tester for multi-core optical fiber according to claim 1, wherein the reflective mirror is a semi-transparent and semi-reflective reflector which is rotatably installed in the incident end.

9. The polarity, insertion loss and return loss tester for multi-core optical fiber according to claim 1, wherein the imaging device is a camera or a sensor, and the camera or the sensor is installed in the reflection light channel through a translation bracket.

10. The polarity, insertion loss and return loss tester for multi-core optical fiber according to claim 1, wherein the lens assembly is a convex lens or a combination of a convex lens and a concave lens.
